(19) United States
(12) Patent Application Publication
(10) Pub. No.: US 2010/0159112 A1
(43) Pub. Date: Jun. 24, 2010

(54) Method and System for Producing Viscous Fruit Product

(76) Inventors: John Alan Madsen, Kelowna (CA); Cherry Elizabeth Nicholson, Kelowna (CA)

Correspondence Address: RONALD I. EISENSTEIN;NIXON PEABODY LLP, 100 SUMMER STREET, BOSTON, MA, 02110, US

(21) Appl. No.: 12/506,046

(22) Filed: Jul. 20, 2009

Related U.S. Application Data
(60) Provisional application No. 61/081,968, filed on Jul. 18, 2008.

(51) Int. Cl. A23L 1/201; B65D 81/20

(52) U.S. Cl. 426/615; 99/472

(57) ABSTRACT

Described herein are a method and system for cooking viscous fruit product composed of a high proportion of fruit from a fruit based slurry. The method includes heating the slurry in a heat exchanger, and subjecting the slurry to a vacuum in a vacuum chamber. The vacuum removes moisture from the slurry. The system includes a heat exchanger for heating the slurry to promote evaporation, and a vacuum chamber fluidly coupled to the heat exchangers. The vacuum chamber generates a vacuum that removes moisture from the slurry. Using the described method and system, a viscous intermediate fruit product composed of a high proportion of fruit, as high as 100% fruit, can be made. The viscous intermediate fruit product can subsequently be formed into consumable end fruit products.

### CROSS-REFERENCE TO RELATED APPLICATIONS

This application claims benefit of the U.S. provisional patent application No. 61/081,968 filed Jul. 18, 2008, the content of which is incorporated herein by its entirety.

### FIELD OF THE INVENTION

The present invention relates to a method and system for producing a viscous intermediate fruit product from a precursor fruit product, wherein the intermediate fruit product contains a high proportion of fruit and is suitable for forming into a consumable end fruit product.

### BACKGROUND OF THE INVENTION

Increasingly, consumers are concerned about eating healthily. Generally, consumers associate eating healthily with consuming fruit snacks that contain a high proportion of fruit. Such fruit snacks are often perceived as being healthier than fruit snacks that contain additives such as processed or refined sugars, starches, gelatins, gums and preservatives. An example of fruit snacks containing a high proportion of fruit is Sun-Rype™ Products Ltd.'s (“Sun Rype's”) “Fruit To Go”™ line of fruit snacks.

In order to produce a consumable end product containing a high proportion of fruit (i.e., the fruit snack), raw materials forming a precursor fruit product can be transformed into an intermediate product having appropriate properties for forming into the end product. In particular, it is helpful if the intermediate product has certain physical properties, such as a sufficient viscosity, suitable for mechanical forming into the end product. There are a number of challenges in manufacturing a product having a high concentration of fruit. Such challenges include:
cooking the precursor product in slurry form at too high a temperature or moving the slurry through processing equipment at too high a temperature may burn or discolour the slurry, and could consequently negatively affect the flavour, colour, texture, and shape of the resulting end fruit product;
cooking the slurry increases its Brix level, which consequently increases the slurry's thickness, or viscosity. Increased viscosity makes the slurry prone to clogging the pipes and equipment used during cooking; and
the increased Brix level, along with the high proportion of fruit content, increases the slurry's stickiness. Increased stickiness makes the slurry prone to sticking to equipment and makes the resulting fruit snack prone to sticking to its wrapping and to consumers' fingers and faces.

These problems can be greatly reduced when cooking a slurry that is not composed of a high proportion of fruit, as the additives typically found in such slurries, such as gelatins, starches, and refined sugars, can be used to create a slurry with a high Brix content at lower cooking temperatures and that is not as sticky or viscous as a slurry containing a high proportion of fruit.

Consequently, there is a need for a method and system for manufacturing a viscous intermediate fruit product suitable for mechanical forming into a consumable end product composed of a high proportion of fruit and formed from a precursor fruit product slurry.

### SUMMARY OF THE INVENTION

Accordingly, it is an object of the invention to provide at least one of a system or method for cooking a slurry composed of a high proportion of fruit that addresses at least one of the problems of the prior art.

According to one aspect of the invention, there is provided a method of continuously producing fruit leather from a fruit mass. The fruit leather does not include added sugar or fat. The fruit mass can include a share of dry substance of at least 50% and a share of water. By “share”, it is meant “proportion”; and by “dry substance”, it is meant “dissolved solids”, which, to a good approximation, is equivalent to the Brix level of the fruit mass (i.e.: a fruit mass having 50% dissolved solids has, to a good approximation, a Brix level of 50° Brix). The fruit mass is cooked by exposing it to a vacuum for less than one minute. In this way, the share of water in the fruit mass is reduced so as to increase the share of dry substance in the fruit mass to between approximately 80% and 90%. The fruit mass can then be formed into the fruit leather.

According to another aspect of the invention, there is provided an apparatus for continuously producing fruit leather from a fruit mass. The fruit leather does not include added sugar or fat. The fruit mass includes a share of dry substance of at least 50% and a share of water. The apparatus includes a processing unit for the fruit mass and a discharging unit for the fruit leather. The processing unit includes a thin film cooking apparatus, an evaporating chamber and a vacuum pump. The evaporating chamber is arranged downstream of the thin film cooking apparatus and it has a lower end. The vacuum pump is connected to the evaporating chamber, and it is designed and arranged to produce a vacuum in the evaporating chamber. The processing unit is designed and arranged to cook the fruit mass while exposed to vacuum for less than one minute in a way to reduce the share of water in the fruit mass and to increase the share of dry substance in the fruit mass to between approximately 80% and 90%. The discharging unit is arranged at the lower end of the evaporating chamber, and it is designed and arranged to discharge the dried fruit leather from the evaporating chamber.

Using the aforedescribed method and apparatus, products having a very high share of fruit mass can be produced without adding sugar or fat to the fruit mass. When a product formed from 100% fruit is produced, the product has at most a share of sugar resulting from the natural sugar of the fruit. In this way, one attains a very natural and healthy product. Such a product is called dried fruit or “fruit leather”.

The fruit mass used for producing such products may be fruit puree, natural fruit juice, concentrated or condensed fruit juice, fruit concentrate, fruit mesh, fruit pulp or a combination thereof. As neither sugar nor fat are added during the manufacture of products made from 100% fruit, such products are not considered to be confectionaries.

Using the aforedescribed method and apparatus, it is possible to continuously produce products from fruit mass without adding sugar or fat. A substantial component of the products is fruit, and the final products have a share of dry substance in the fruit mass of between 80% and 90%. The products may include comparatively low shares of filling materials such as flavors, colors, liquid glucose, pectin, glucose, fructose, and the like. Such a product is made by reducing the share of water of the fruit mass by continuously cooking the fruit mass under the influence of vacuum for a short period of time.

In contrast to prior art methods, drying does not take place for several hours or even days, but instead only for a relatively short period of time. This short-term drying can be a gentle process that does not damage components of the fruit mass such as fruit pulp and fruit fibers. Instead, such components are present in the final, dried product more or less identically to how they are found in the fruit mass prior to cooking. Vitamins and other valuable components of the fruit mass do not substantially degrade during the cooking and drying process. Consequently, the resultant product can be very healthy. Neither sugar, fat, nor oil need be added to the fruit mass. The components that make up the fruit mass can be processed in a reservoir located upstream and the fruit mass can be pumped downstream through conduits. The fruit mass can thereby be continuously produced and cooked under the influence of a vacuum.

The fruit mass can be cooked at relatively low temperatures; for example, at temperatures below 120° C. When processing delicate fruit masses, the cooking temperature can be lowered to below 100° C.

Advantageously, the system and method can be used in a continuous, as opposed to a batch, process for cooking viscous fruit product. In other words, the combination of the heat exchangers and the vacuum chamber allow the system and method to cook viscous fruit product without interruption, which allows for a viscous fruit product of a consistent quality to be created. This is in contrast to a batch process, wherein due in part to the long residence time of the viscous fruit product in the processing line equipment and due to changes in processing conditions between batches, the quality of the cooked viscous fruit product between batches may not be consistent.

After short-term cooking of the fruit mass, the resulting fruit leather is conveyed into the atmosphere, and the products are formed under atmospheric pressure. The products may be formed in different ways, especially by rollers or by an extruder with which lines or other elongated products of various cross-sections can be produced.

According to another aspect, the fruit mass can be continuously cooked according to a “thin film method” with a residence time of the fruit mass in the thin film cooking apparatus of approximately between 15 to 20 seconds. The thin film method uses a thin film cooking apparatus having a rotor and a stator. A comparatively small annular gap is formed between the rotor and the stator. The rotor in the region of the gap includes a plurality of scraping elements serving to repeatedly remove the mass from the heat transfer surfaces and to mix the mass. The thin film cooking apparatus may be heated by steam, electrically or in any other suitable way as known to persons skilled in the art.

Depending on the desired dry substance, or Brix level, of the final product, in one aspect short-term cooking may be performed under a vacuum with a pressure of between approximately 95000 and 30000 Pascal, and alternatively between approximately 70000 and 30000 Pascal. When using the thin film method, it is possible to cook the mass at temperatures of less than 100° C. Alternatively, it is also possible to apply pressures below atmospheric pressure in a range of approximately between 95000 to 70000 Pascal such that the fruit mass has a temperature of between approximately 115° C. to 108° C.

According to another aspect, there is provided an apparatus for producing products from a fruit mass including a processing unit for processing the fruit mass and a forming unit (or forming apparatus) for forming the fruit leather to attain the single products; i.e., a forming unit for forming the fruit leather that results from processing into individual fruit products suitable for wrapping. The processing unit includes a thin film cooking apparatus and an evaporating chamber including a vacuum pump, the evaporating chamber being under the influence of vacuum and being located downstream of the thin film cooking apparatus. A discharging unit is arranged at the lower end of the evaporating chamber, the discharging unit serving to discharge the dried fruit mass, or fruit leather. The thin film cooking apparatus can be a thin film cooking apparatus for producing confectionaries, as is known to persons skilled in the art. Such a thin film cooking apparatus includes a rotor and a stator, the mass flowing through the gap between the rotor and the stator. The rotor includes a plurality of scraping elements designed and arranged to repeatedly remove the mass from the surface of the stator and to mix the mass. Such a thin film cooking apparatus may be heated by steam. An evaporating chamber is located downstream of the thin film cooking apparatus, the evaporating chamber being under the influence of, or subject to, a vacuum that is produced by a vacuum pump. The thin film cooker or any portion thereof may also be under the influence of the vacuum. A connecting conduit can be arranged, or disposed, between the evaporating chamber and the thin film cooking apparatus in order to subject the thin film cooker to the vacuum. The vacuum pump can serve to produce the desired negative pressure and to remove vapors. In this way, the fruit mass is dried in the evaporating chamber in a way that the share of dry substance is substantially increased to be in a region of between approximately 80% and 90% (i.e. between approximately 80° Brix and 90° Brix).

The apparatus can be operated to continuously produce fruit leather of constant quality in a reproducible way. The required space is very small, especially when compared to drying chambers known in the prior art in which the mass is located on large metal sheets and the like on which the mass is dried for many hours or even days. The short residing time in the thin film cooking apparatus has a positive influence on the quality of the product. The components of the fruit mass are gently treated. Components such as vitamins, but also the structure of the fruit mass, for example the fruit fibers and the fruit pulp, are not damaged.

In one aspect, the vacuum pump may be designed and arranged to produce a pressure below atmospheric pressure of between approximately 95000 to 30000 Pascal and to discharge the vapors being produced during cooking, and alternatively, the vacuum pump can produce a pressure below atmospheric pressure of between approximately 70000 Pascal and 30000 Pascal. In this way, substantial drying takes place in the evaporating chamber. The pressures that are used depend on the properties of the fruit contained in the fruit mass and the desired dry substance in the final product. For example, when using a pressure of 95000 Pascal in the evaporating chamber, the fruit mass can have a temperature of approximately 115° C. When using pressure of approximately 70000 Pascal, the temperature of the fruit mass can be approximately 108° C. When using a vacuum with a pressure of approximately 30000 Pascal, the fruit mass can have a temperature of approximately 90° C.

It is especially advantageous if the discharging unit includes a vacuum helix. Such a vacuum helix or vacuum screw allows the evaporating chamber to be effectively sealed, especially when a substantial vacuum is used. However, it is also possible that the discharging unit includes a displacement pump to convey the fruit leather from the evaporating chamber under the influence of vacuum into the atmosphere and to there continue processing of the mass.

The discharging unit may be connected to the forming unit by a conduit along which one or more adding stations for adding an addition in the form of one or both of colors and flavors are located. Optionally, a mixing unit that is designed to be static (i.e.: a static mixer) is arranged downstream of the adding station to mix the fruit mass with the colors and/or the flavors before the mass reaches the place where its shape is formed. The shape of the mass may be formed in different ways, such as by using rollers as forming elements with which a continuous strip of the mass is formed, which may be cut in a longitudinal direction and in a transverse direction to attain bar-like products. However, it is also possible to use an extruder as the forming element with which lines of different cross-sections can be produced, these lines capable of being cut in a transverse direction to attain the final products.

### BRIEF DESCRIPTION OF THE DRAWINGS

In the accompanying drawings, which illustrate an exemplary embodiment of the present invention:

FIG. 1 is a schematic view of a system for manufacturing a viscous intermediate fruit product (“kitchen”) from a precursor fruit product slurry, wherein the intermediate fruit product is suitable for forming into a consumable end product having a high proportion of fruit.

FIG. 2 is top plan view of the kitchen.

FIG. 3 is a side elevation view of a portion of the kitchen.

FIG. 4 is a front elevation view of the portion of the kitchen.

FIG. 5 is a flow chart depicting steps of an exemplary method for manufacturing the intermediate fruit product.

### DETAILED DESCRIPTION OF EXEMPLARY EMBODIMENTS

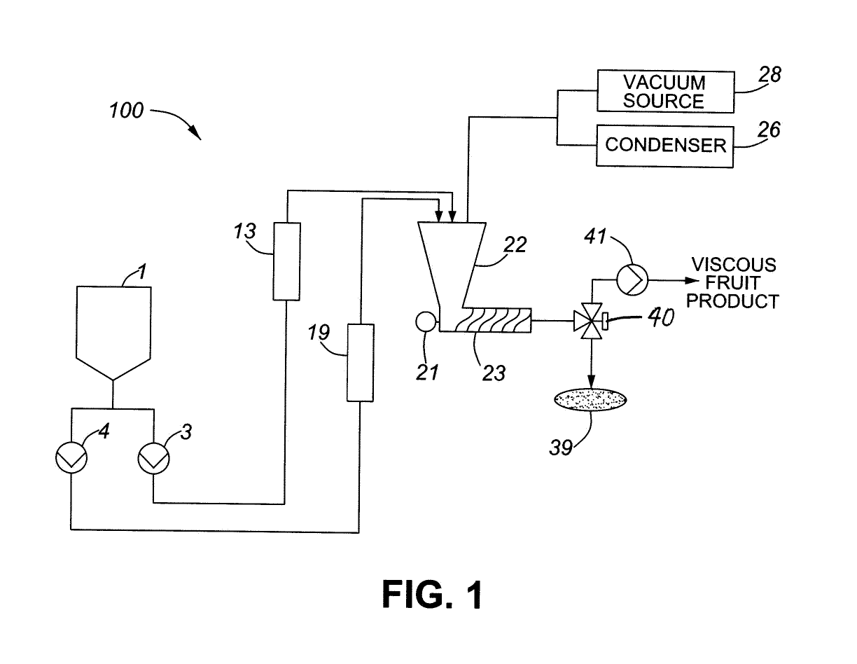

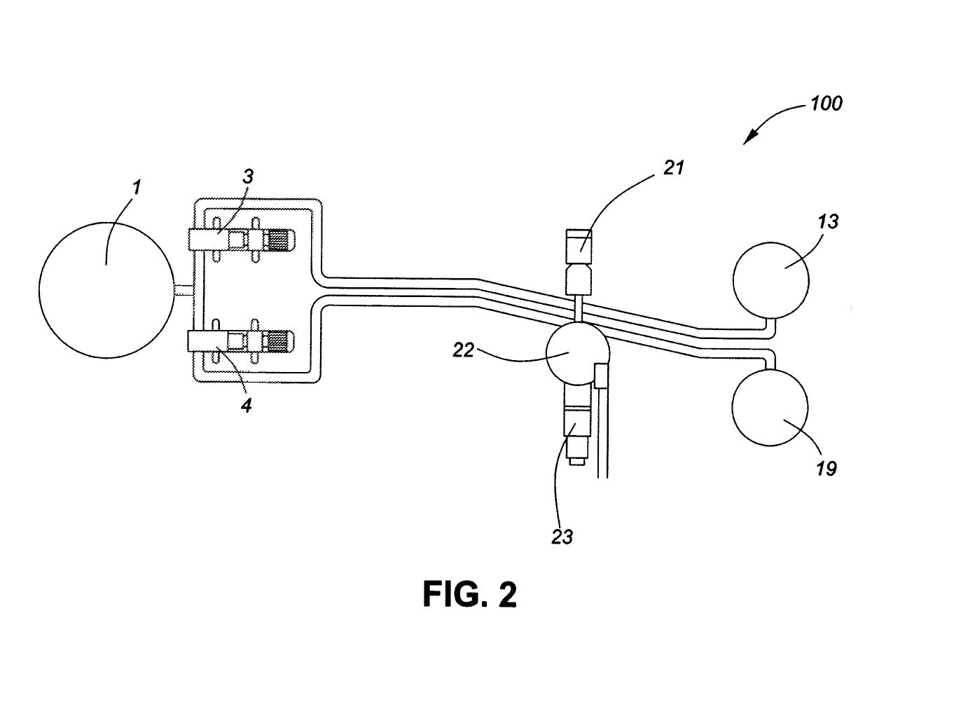

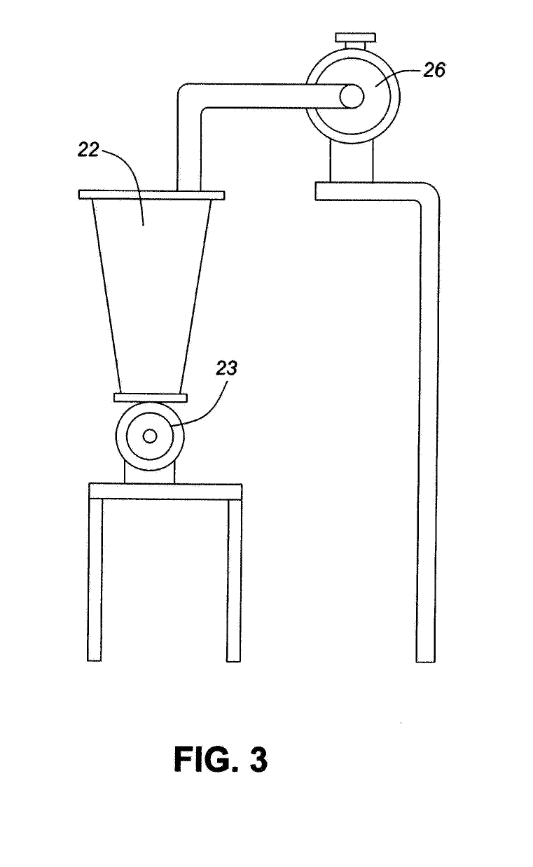

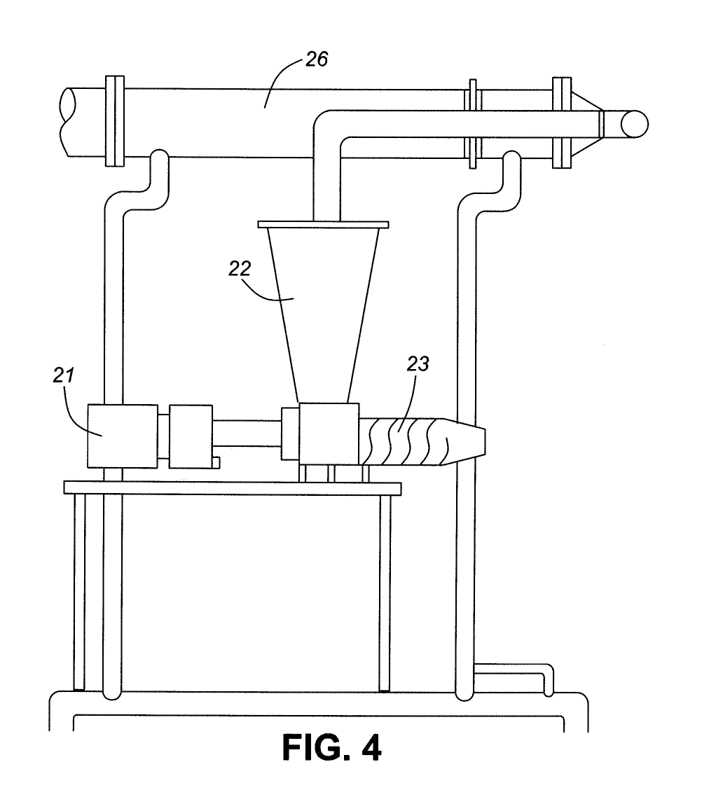

Referring generally to FIGS. 1-4, and according to a first embodiment, a system 100 (“kitchen”) is provided for manufacturing an intermediate fruit product from a precursor fruit product. The precursor fruit product is a fruit mass in a slurry form (hereinafter referred to as “slurry”), and the intermediate fruit product is viscous and has other physical properties suitable for mechanical forming into a consumable end fruit product. One exemplary type of a consumable end fruit product is a “leathery fruit mass” or “fruit leather”, which is slurry that has been dried to remove some of the slurry's moisture.

The slurry can be made of a variety of ingredients, and its composition will vary depending on the desired properties of the end product. The slurry can have between about 50% to about 100% fruit material; alternatively about 60% to about 100% fruit material; alternatively about 70% to about 100% fruit material; alternatively about 80% to about 100% fruit material; alternatively about 90% to about 100% fruit material; or alternatively, as in the first embodiment described below, 100% fruit material. In this application, “fruit” or “fruit material” includes any material derivable from fruit, including isolated pectin, but excludes non-fruit materials such as refined sugars, starches, and oils. Generally, the slurry can contain various concentrations of fruit puree concentrates, such as apple, pear, or strawberry puree concentrate, various juice concentrates, pectin, and ascorbic acid. These ingredients are mixed together in a mixing tank (not shown) such that the resulting slurry is roughly 50° Brix and has a pH of roughly 3.8. Following mixing, the resulting slurry is transferred to a holding tank 1 to await further processing.

From the holding tank 1, the slurry is pumped out of the tank 1 so that the process of cooking the slurry can begin. In this exemplary embodiment, such pumping is accomplished by two mass infeed pumps 3, 4. Suitable mass infeed pumps 3, 4 are positive displacement pumps. The flow rate of the pumps 3, 4 can be monitored and controlled using a flowmeter. In this exemplary embodiment, the flow rate of the slurry through each pump 3, 4 is approximately 600 kg/hour. Each pump 3, 4 feeds the slurry into one of two thin film cooking apparatuses in the form of scrape surface heat exchangers 13, 19 from the holding tank 1 via mass infeed pipes; the heat exchangers 13, 19 may be operated in “bottom-up” mode. The temperature in the heat exchangers 13, 19 will vary with the residence time of the slurry in the exchangers 13, 19. The residence time of the slurry within the heat exchangers 13, 19 is about 30 seconds.

When the slurry exits the heat exchangers 13, 19, it is sucked into an evaporating chamber in the form of a vacuum chamber 22; a connecting conduit fluidly couples the heat exchangers 13, 19 and the vacuum chamber 22. The heat exchangers 13, 19 and the vacuum chamber 22 together form a processing unit for cooking the slurry. The purpose of the vacuum chamber 22 is to remove moisture from the slurry so as to elevate the Brix content of the slurry. The vacuum chamber 22 in the depicted exemplary embodiment is set to produce a vacuum of −0.55 Bar (an absolute pressure of about 47000 Pa within the vacuum chamber). The heat exchangers 13, 19 heat the slurry such that the temperature measured in the vacuum chamber 22 is between 90° C. and 96° C. The vacuum of −0.55 Bar is sufficient to draw the slurry into the vacuum chamber 22 from the heat exchangers 13, 19 without employing any kind of additional pump or motor. Consequently, a portion of the heat exchangers 13, 19 may be subject to the vacuum, and heating of the slurry within the heat exchangers 13, 19 may be done under vacuum. The residence time of the slurry through the vacuum chamber 22 is minimal (on the order of about 10 seconds) in that the slurry enters the vacuum chamber 22, falls through the vacuum chamber 22, and is then forthwith extracted from the vacuum chamber 22 via a discharging unit in the form of a vacuum helix 23, hereinafter referred to as a “discharge auger”, located at a lower end of the vacuum chamber 22. The discharge auger 23 is powered by a motor 21 that rotates the auger 23 at a frequency such that the slurry is removed from the vacuum chamber 22 approximately as fast as it enters the vacuum chamber 22. The flow rate of the slurry as it leaves the vacuum chamber 22 is approximately 11.5 kg/min when each heat exchanger 13, 19 is feeding slurry to it at a rate of 600 kg/hr, for a total rate of 1,200 kg/hr.

Generally, it is advantageous to use the highest vacuum level possible in the vacuum chamber 22 so long as the slurry can be successfully extracted from the vacuum chamber 22. A higher vacuum level allows more moisture to be extracted from the slurry at any given temperature, and consequently allows the temperature used in the heat exchangers 13, 19 and vacuum chamber 22 to be reduced, thus obviating problems, such as discolouration, burning, and undesirable changes in flavour and texture that result from overcooking the slurry.

Schematically represented in FIG. 1 are a condenser 26 and a vacuum source 28. The condenser 26 accepts evaporated moisture from the vacuum chamber 22 and condenses it into liquid water for disposal. The vacuum source 28 can be a vacuum pump that generates the vacuum used in the vacuum chamber 22.

Following the vacuum chamber 22, the creation of a viscous fruit product suitable for shaping or forming into fruit snacks is complete; such a viscous product is considered an intermediate product, as the viscous product will still have to be mechanically formed into a suitable end product. Using a forming unit such as rollers or an extruder, the viscous fruit product can, for example, be formed via rollers into slabs for cutting into strips, extruded and cut into elongated rope-like products or smaller bite-sized pieces, or used to form a bar shaped end product. The intermediate fruit product has a Brix level of approximately 84-88° Brix. Overall, the viscous fruit product is not too sticky, is not too chewy, has good flavour and colour, and is not burnt nor caramel tasting.

Optionally, following and fluidly coupled to the auger 23 can be a three-way valve 40 that is coupled to a booster pump 41 and a drain 39. In the event that the pressure in the piping of the kitchen 100 increases to a level such that it becomes desirable to vent the viscous fruit product to prevent damage to the piping, the three-way valve 40 can be set to divert the viscous fruit product out through the drain 39, thus alleviating pressure in the piping. Optionally, the three-way valve 40 can also be used to vent the viscous fruit product if the Brix level of the fruit product has not yet reached a desired level, so as to aid in ensuring that only fruit product of the desired Brix level is conveyed downstream of the three-way valve 40.

Following the vacuum chamber 22 the viscous fruit product can be conveyed directly to the booster pump 41. The booster pump 41 propels the viscous fruit product downstream where, for example, it may undergo further processing. The booster pump 41 can be a positive displacement pump that pumps at about 690 kg/hr. In the depicted embodiment wherein the auger 23 is used to extract slurry from the vacuum chamber 22, the booster pump 41 is configured to pump at a rate such that the back pressure exerted on the auger 23 by the slurry is less than 2 Bar. If the back pressure is greater than 2 Bar, the auger 23 may be incapable of extracting slurry from the vacuum chamber 22 and the flow of the slurry through the kitchen 100 will cease.

While the above text describes the operation of one embodiment of the kitchen 100 in steady-state, prior to entering steady-state operation certain start-up steps that transition the kitchen 100 from a non-operational state to steady-state should be followed. These steps include:
1. Heat the vacuum chamber 22, discharge auger 23, booster pump 41 and associated pipeworks to a temperature of about 95° C. These items can be heated using, for example, steam jacketing.
2. Set the three-way valve 40 to divert all slurry out to the drain 39. This allows the auger 23 to discharge slurry from the vacuum chamber 22 without being subjected to any back pressure.
3. Pre-heat the heat exchangers 13, 19 to about 85° C.
4. Pump slurry from the holding tank 1 to the heat exchangers 13, 19 using the mass infeed pumps 3, 4 at a rate of approximately 630 kg/hour.
5. Operate the auger 23 at approximately 725 kgs/hr and the booster pump 41 at approximately 905 kgs/hr, and slowly and repeatedly apply and remove the vacuum of −0.55 Bar to the vacuum chamber 22 until the auger is primed. As the auger 23 is not subject to any back pressure, the slurry will prime the auger 23, which will allow it to extract slurry from the vacuum chamber 22 when the kitchen 100 is operating in steady-state. If the auger 23 is not primed, cavitation will occur and the slurry will not properly discharge from the vacuum chamber 22.
6. Following priming of the auger 23, set the three-way valve 40 to divert slurry to the booster pump 41 instead of the drain 39.
7. Increase the temperature of the heat exchangers 13, 19 to their steady-state value such that the temperature of the slurry within the vacuum chamber 22 is between about 90-96° C.
8. Sample the slurry exiting the kitchen 100 for Brix. When the slurry has reached a Brix content of 84-88° Brix, the kitchen 100 can be transitioned entirely to steady-state.

### Alternative Embodiments

Alternatively, and according to a second embodiment, instead of using the auger 23, a pump (not shown), such as a positive displacement pump, can be used to pump the slurry from the vacuum chamber 22. As the inlet of this pump is considerably smaller than the auger 23 surface area inside the vacuum chamber, it is not able to extract slurry from the vacuum chamber 22 at the same volume as the auger 23, and the vacuum chamber 22 is consequently operated at a lower vacuum pressure when used in conjunction with the pump as opposed to the auger 23. Operating the chamber 22 at a lower pressure allows the product to free fall into the pump inlet. As opposed to the −0.55 Bar vacuum that is possible when the auger 23 is used, a vacuum no larger than −0.3 Bar (an absolute pressure of about 72000 Pa within the vacuum chamber), for example, should be used if the pump is used to extract slurry from the vacuum chamber 22. The residence time of the slurry within the vacuum chamber 22 in this alternative embodiment is about 20 seconds. Consequently, with a lower vacuum, a higher slurry temperature is needed in the vacuum chamber 22 in order to extract the desired amount of water. At a vacuum of −0.3 Bar, the heat exchangers 13, 19 can be heated such that the temperature measured in the vacuum chamber is between 105-108° C. The resulting viscous intermediate fruit product of this alternative embodiment has a Brix level of about 84° Brix to about 86° Brix. Aside from using the pump instead of the auger 23 to remove the slurry from the vacuum chamber 22 and the associated changes in process parameters, this alternative embodiment is much the same as the embodiment utilizing the auger 23, as described above.

As a consequence of using a vacuum of −0.3 Bar as opposed to a vacuum of −0.55 Bar when utilizing the auger 23, the viscous fruit product that results from this alternative embodiment has a higher moisture content than that of the viscous fruit product produced using the embodiment having the auger 23. Consequently, during mechanical forming of the viscous fruit product, more drying of the viscous fruit product formed as a product of this alternative embodiment may be required than the viscous fruit product formed as a result of the embodiment utilizing the auger 23 and a vacuum of −0.55 Bar.

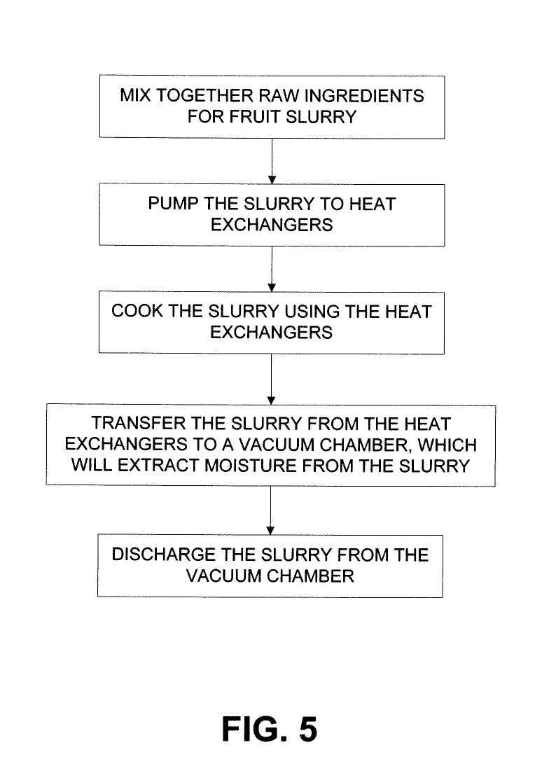

FIG. 5 graphically depicts some of the steps involved in producing the intermediate fruit product as described with respect to the above embodiments.

As with the first embodiment of the kitchen 100, the above text relating to the second embodiment describes the operation of the second embodiment in steady-state operation. Prior to entering steady-state operation certain start-up steps that transition the kitchen 100 from non-operational to operating in steady-state should be followed. These steps include:
1. Heat the vacuum chamber 22, discharge auger 23, booster pump 41 and associated pipeworks to a temperature of about 95° C. These items can be pre-heated using, for example, steam jacketing.
2. Pre-heat the heat exchangers 13, 19 to about 107° C.
3. Pump slurry from the holding tank 1 to the heat exchangers 13, 19 using the mass infeed pumps 3, 4 at a rate of 600 kg/hour. When the slurry enters the vacuum chamber 22, operate the pump that pumps slurry from the chamber at approximately 575 kgs/hr.
4. Increase the temperature of the heat exchangers 13, 19 to their steady-state temperature such that the temperature in the vacuum chamber is between about 106-108° C.
5. Apply the vacuum of −0.3 Bar to the vacuum chamber 22.
6. When the level of slurry in the vacuum chamber 22 is approximately 6 inches deep, increase the frequency of the pump that pumps slurry from the chamber 22 to about 850 kgs/hr.
7. Sample the slurry exiting the kitchen 100 for Brix level. When the slurry has a Brix content of 84-86° Brix, the kitchen 100 can be transitioned entirely to steady-state.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment.

1. A method of continuously producing fruit leather from a fruit mass, the fruit leather not including added sugar or fat, the fruit mass including a share of dry substance of at least 50% and a share of water, comprising the steps of:
(a) cooking the fruit mass exposed to vacuum for less than one minute in a way to reduce the share of water in the fruit mass and to increase the share of dry substance in the fruit mass to approximately between 80% and 90%; and
(b) forming the fruit mass to attain the fruit leather.

2. The method of claim 1, wherein the fruit mass is cooked at a temperature of less than approximately 120° C.

3. The method of claim 1, wherein the fruit mass after cooking is exposed to atmospheric pressure to form the products at atmospheric pressure.

4. The method of claim 1, wherein the fruit mass is cooked under the influence of vacuum for approximately 15 to 20 seconds.

5. The method of claim 2, wherein the fruit mass is cooked under the influence of vacuum for approximately 15 to 20 seconds.

6.-10. (canceled)

11. An apparatus for continuously producing fruit leather from a fruit mass, the fruit leather not including added sugar or fat, the fruit mass including a share of dry substance of at least 50% and a share of water, comprising:
(a) a processing unit for the fruit mass, said processing unit including
(i) a thin film cooking apparatus,
(ii) an evaporating chamber, said evaporating chamber being arranged downstream of said thin film cooking apparatus, said evaporating chamber having a lower end,
(iii) a vacuum pump, said vacuum pump being connected to said evaporating chamber and being designed and arranged to produce a vacuum in said evaporating chamber, said processing unit being designed and arranged to cook the fruit mass exposed to vacuum for less than one minute in a way to reduce the share of water in the fruit mass and to increase the share of dry substance in the fruit mass to approximately between 80% and 90%; and
(iv) a discharging unit for the fruit leather, said discharging unit being arranged at the lower end of said evaporating chamber, said discharging unit being designed and arranged to discharge the dried fruit leather from said evaporating chamber.

12.-13. (canceled)

14. The apparatus claim 11, wherein said discharging unit includes a displacement pump.
